(19) United States
(12) Patent Application Publication
(10) Pub. No.: US 2019/0317198 A1
(43) Pub. Date: Oct. 17, 2019

(54) GRATING DEVICE, LIGHT-EMITTING UNIT and LIGHT DETECTION METHOD

(71) Applicant: Qiang WANG, San Carlos, CA (US)

(72) Inventor: Qiang WANG, San Carlos, CA (US)

(21) Appl. No.: 16/384,619

(22) Filed: Apr. 15, 2019

Related U.S. Application Data
(60) Provisional application No. 62/658,360, filed on Apr. 16, 2018.

(51) Int. Cl. G01S 7/499; G02F 1/313; G01S 7/481

(52) U.S. Cl. CPC G01S 7/499; G02F 1/313; G02F 2203/07; G02F 2203/05; G02F 2203/24; G01S 7/4814

(57) ABSTRACT

The present disclosure relates to a grating device, a light-emitting unit and a light detection method. The grating device includes a first waveguide and a second waveguide. A first input beam of a TE mode propagates through the first waveguide, and a second input beam of a TM mode propagates through the second waveguide. Output beams are obtained by diffraction which steer the first and second input beams. The first and second input beams have different steering angles at least at one wavelength. The grating device tunes a steering angle by varying a wavelength. The two input beams have different polarization modes, which increases an angle range of steering angles by wavelength tuning. A lidar using the grating device can expend an angle range of detection.

### CROSS REFERENCE TO RELATED APPLICATION(S)

This application claims priority to U.S. provisional application Ser. No. 62/658360, filed on Apr. 16, 2018, which is incorporated herein by reference in its entirety.

### BACKGROUND OF THE DISCLOSURE

### Field of the Invention

The present disclosure relates to a lidar technology, and more particularly, to a grating device, a light-emitting unit and a light detection method.

### Description of the Related Art

A lidar (light detection and ranging) has been widely used in the fields of autopilot, optical wireless communication, environmental topographic survey, and the like. Similar to a microwave radar, the lidar illuminates the object and detects a reflected light signal of the object, and processes the reflected light signal to obtain information about position and velocity of the object.

A conventional lidar needs an expensive opto-mechanical system to enlarge a detection range. For example, a mirror may be used to steer a laser beam in the lidar. In recent years, new technologies, such as silicon photonics, are used to integrate basic functions of a lidar on a silicon substrate to form a single chip, so as to reduce the size and the manufacturing cost of the lidar.

However, it is difficult to integrate opto-mechanical elements such as a mirror in a chip. Instead, the lidar may use two tuning approaches to control a steering angle of a laser beam, i.e. phase tuning and wavelength tuning. In phase tuning, a phase difference between adjacent optical elements is adjusted through thermo-optical effect. Then through the diffraction effect, the laser beam changes its propagation direction in the far field, with a steering angle being tuned by the phase difference. In wavelength tuning, a tunable laser source (TLS) is used to generate a laser beam of a corresponding wavelength, and then an outgoing laser beam is generated by a diffraction effect of a grating coupler (GC), and an steering angle of the outgoing beam corresponds to a wavelength, thereby the steering angel of the laser beam is adjusted by turning the wavelength.

It is advantageous to steer the laser beam through wavelength tuning, because wavelength tuning only requires the control wavelength of TLS. In the phase tuning, however, control of multiple heating elements to achieve the desire phase difference is required. A combination of wavelength turning and phase tuning approaches could be very beneficial. For example, in x direction, the beam steering through phase tuning is used; yet in y direction, the beam steering through wavelength tuning is used.

One drawback of the wavelength tuning is that a broad wavelength range can only be translated to a narrow or moderate angle range. For example, a wavelength range of around 80 nm can only be translated to an angle range of 15 degrees. It is challenging for the TLS to provide a broad wavelength range.

In view of the foregoing, there is a great need to expand an adjustable angle range of a laser beam in the wavelength tuning so as to expand a detection range of a lidar.

### BRIEF DESCRIPTION OF THE DISCLOSURE

In the present invention, one object of the present disclosure is to provide a grating device, a light-emitting unit and a light detection method. In the grating device, first and second input beams have different polarization modes and propagate in different waveguides, respectively. By stitching the angle ranges of the first and second input beams, a lidar using the grating device can expand its detection range.

According to a first aspect of the present disclosure, there is provided a grating device, comprising: a first waveguide, through which a first input beam of a transverse electrical (TE) mode propagates; and a second waveguide, through which a second input beam of a transverse magnetic (TM) mode propagates, wherein said grating device generates output beams by steering said first and second input beams by diffraction, with different steering angles at least at one wavelength.

Preferably, the grating device further comprises a substrate; and a blocking layer on said substrate, wherein said first waveguide is provided on a first region of said blocking layer, and said second waveguide is provided on a second region of said blocking layer.

Preferably, each of the first and second waveguides comprises an array of parallel strips and the strips extend in a direction perpendicular to propagation direction of the first and second input beams.

Preferably, the first waveguide has a filling factor, which is a ratio calculated as a width of each strip to a period of the strips, greater than the filing factor of the second waveguide.

Preferably, the first and second input beams propagate in opposite directions.

Preferably, steering angles of the output beams are tuned by changing wavelengths of the first and second input beams.

Preferably, the first input beam generates an output beam within a first angle range, the second input beam generates an output beam within a second angle range, and the first angle range is continuous with, overlaps with, or separates from the second angle range.

Preferably, the grating device further comprises a gap which separates the first waveguide from the second waveguide.

Preferably, the grating device further comprises a cladding layer on the first and second waveguides.

Preferably, the first and second waveguides have refraction indexes greater than that of the blocking layer.

Preferably, each of the first and second waveguides is made from any selected from the group consisting of silicon, silicon oxide, silicon nitride, gallium arsenide, indium phosphide, and liquid crystal, or combination of them.

Preferably, the substrate and the blocking layer are a substrate and a buried layer of a silicon-on-insulator (SOI) wafer, and the first and second waveguides are formed by patterning a silicon layer of the SOI wafer.

Preferably, the grating device further comprises a cladding layer of silicon oxide on the first and second waveguides.

According to a second aspect of the present disclosure, there is provided a light-emitting unit, comprising: a polarization controller configured to generate a first input beam of a TE mode and a second input beam of a TM mode; and one or more grating devices which are coupled to the polarization controller to receive the first and second input beams, wherein each of the one or more grating devices comprises: a first waveguide, through which a first input beam of a TE mode propagates; and a second waveguide, through which a second input beam of a TM mode propagates, wherein said grating device generates output beams by steering said first and second input beams by diffraction, with different steering angles, at least, at one wavelength.

Preferably, the grating device further comprises a substrate; and a blocking layer on said substrate, wherein said first waveguide is provided on a first region of said blocking layer, and said second waveguide is provided on a second region of said blocking layer.

Preferably, each of said first and second waveguides comprises an array of strips which are parallel with each other and extends in a direction perpendicular to propagation direction of said first and second input beams.

In one embodiment, the source beam has a polarization mode, either a TE mode or a TM mode, and the polarization controller comprises: an optical switch configured to selectively provide a source beam to a first path or to a second path, wherein the source beam provided to the first path or to the second path is the first input beam; and a polarization rotator which is coupled to the optical switch through the second path and converts the source beam into a different polarization mode, as the second input beam, wherein the optical switch provides the first input beam to the first waveguide through the first path, and the polarization rotator provides the second input beam to the second waveguide through a third path.

In another embodiment, the source beam has a polarization mode which is adjusted to be either a TE mode or a TM mode, and the polarization controller comprises: an optical switch which is coupled to the first waveguide through a first path and to the second waveguide through a second path, wherein the optical switch provides a source beam to the first path in a case that the source beam is in the TE mode, as the first input beam, and to the second path in a case that the source beam is in the TM mode, as the second input beam.

In still another embodiment, the source beam is not polarized, and the polarization controller comprises: a polarizing beam splitter which is coupled to the first waveguide through a first path and to the second waveguide through a second path, wherein the polarizing beam splitter is configured to polarize a source beam as the first input beam and to provide the first input beam to the first path, and to polarize the source beam as the second input beam and to provide the second input beam to the second path.

Preferably, the one or more grating devices comprise a plurality of grating devices which share the substrate and the blocking layer.

Preferably, the light-emitting unit further comprises: a first beam splitter, which is coupled between the polarization controller and the plurality of grating devices, is configured to split the first input beam into a plurality of feeding beams, each feeding beam being fed to a first waveguide, corresponding to each of the plurality of grating devices; and a second beam splitter which is coupled between the polarization controller and the plurality of grating devices, and is configured to split the second input beam into a plurality of feeding beams, each feeding beam being fed to the second waveguide, corresponding to each of the plurality of grating devices.

Preferably, each of the first and second waveguides comprises an array of strips, wherein the strips are parallel to each other and the array extends in a direction perpendicular to propagation direction of the first and second input beams.

Preferably, the first waveguide has a filling factor, which is a ratio between a width of each of the strips and a period of the strips, greater than that of the second waveguide.

Preferably, the first and second input beams propagate in opposite directions.

Preferably, the first and second input beams tune steering angles of the output beams by changing wavelengths.

Preferably, the first input beam generates an output beam within a first angle range, the second input beam generates an output beam within a second angle range, and the first angle range continues, overlaps with, or separates from the second angle range.

Preferably, each of the one or more grating devices further comprises a gap which separates the first waveguide from the waveguide.

Preferably, each of the one or more grating devices further comprises a cladding layer on the first and second waveguides.

Preferably, the first and second waveguides have refraction indexes greater than that of the blocking layer.

Preferably, each of the first and second waveguides is made from one selected from the group consisting of silicon, silicon oxide, silicon nitride, gallium arsenide, indium phosphide, and liquid crystal.

Preferably, the substrate and the blocking layer are a substrate and a buried layer of an SOI wafer, and the first and second waveguides are formed by patterning a silicon layer of the SOI wafer.

Preferably, the grating device further comprises a cladding layer of silicon oxide on the first and second waveguides.

According to a third aspect of the present disclosure, there is provided a light detection method, comprising: generating first and second input beams, which have different polarization modes, from a source beam; generating output beams by steering the first and second input beams using first and second waveguides, with steering angles corresponding to wavelengths of the first and second input beams; illuminating the output beams onto an object; obtaining reflected beams from the object to generate a detection signal; and processing the detection signal to represent a distance of the object, wherein the first and second input beams have different steering angles, at least, at one wavelength.

Preferably, the source beam has a polarization mode which is either a TE mode or a TM mode, and the step of generating the output beams comprises: selectively providing the source beam to a first path or selecting the source beam to a second path, wherein the source beam provided to the first path or second path is the first input beam; converting the source beam into the second input beam having a polarization mode different from that of the first input beam; providing the first input beam to the first waveguide through the first path; and providing the second input beam to the second waveguide through a third path.

Preferably, the source beam has a polarization mode which is adjusted to either a TE mode or a TM mode, and the step of generating the output beams comprises: providing the source beam of the TE mode to a first path as the first input beam; and providing the source beam of the TM mode to a second path as the second input beam.

Preferably, the source beam is a broadband beam, and the step of generating the output beams comprises: generating the first input beam by polarizing the source beam to a TE mode and providing the first input beam to a first path; and generating the second input beam by polarizing the source beam to a TM mode and providing the second input beam to a second path.

Preferably, the source beam is not polarized, or polarized in a polarization mode selected from the group consisting of linear polarization of 45-degree angle, linear polarization of 135-degree angle, left-handed circular polarization, and right-handed circular polarization.

Preferably, the step of generating the output beams comprises: splitting the first input beams into a plurality of feeding beams, which are provided to a first waveguide, corresponding to one of the plurality of grating devices; and splitting the second input beams into a plurality of feeding beams, which are provided to the second waveguide, corresponding to one of the plurality of grating devices.

Preferably, the first and second input beams propagate in opposite directions.

Preferably, the steering angles of the output beams are tuned by the first and second input beams by changing wavelengths.

Preferably, the first input beam generates an output beam within a first angle range, the second input beam generates an output beam within a second angle range, and the first angle range is continuous with, overlaps with, or separates from the second angle range.

According to a fourth aspect of the disclosure, there is provided a lidar system, which comprises: a laser source generating a narrow-band source beam with a plurality of wavelengths which are adjusted with time; the aforementioned light-emitting unit, which is coupled with the laser source, receives the source beam from the laser source, generates a plurality of output beams by diffraction, having steering angles corresponding to the plurality of wavelengths, and illuminates the plurality of output beams onto an object; an optical detection unit which obtains reflected beams from the object to generate a detection signal; and a signal processing unit which is coupled with the optical detection unit to receive the detection signal and processes the detection signal to represent a distance of the obj ect.

Preferably, the lidar system further comprises a lens between the optical detection unit and the object, configured to enhance the intensity of the reflected beams.

According to a fifth aspect of the disclosure, there is provided another lidar system, which comprises: a laser source generating a broad-band source beam with a plurality of wavelengths; the aforementioned light-emitting unit which is coupled with the laser source, receives the source beam from the laser source, generates a plurality of output beams by diffraction, having steering angles corresponding to the plurality of wavelengths, and illuminates the plurality of output beams onto an object; an optical detection unit which receives reflected beams from the object to generate detection signals; and a signal processing unit which is coupled with the optical detection unit to receive the detection signals and processes the detection signals to represent a distance of the object.

Preferably, the lidar system further comprises a lens between the optical detection unit and the object, for enhancing the intensity of the reflected beams.

The grating device according to the present disclosure comprises first and second waveguides, through which a first and second input beam having different polarization modes propagate. The first and second input beams may be generated from a source beam. The grating device tunes steering angles of output beams by adjusting wavelength of the source beam. Even in a case that the first and second input beams have the same wavelength, the steering angles of the output beams may be different because the first and second input beams have different refraction indexes. The grating device tunes the steering angles with both of the first and second input beams, and stitches the angle ranges of the first and second input beams. Further, the lidar system using the grating device can expand its detection range.

The grating device has a structure which is compatible with the existing semiconductor process. Therefore, the grating device may be used to form a light-emitting unit using the semiconductor process. The light-emitting unit may be integrated with a laser source and a signal processing unit in a single chip or package. Therefore, the lidar system using the light-emitting unit can reduce its size, manufacturing cost, and power consumption.

### BRIEF DESCRIPTION OF THE DRAWINGS

The above and other objects, advantages and features of the present disclosure will become more fully understood from the detailed description given herein below in connection with the appended drawings, and wherein:

FIG. 1 is a cross-sectional view showing a conventional grating device;

FIG. 2 is a cross-sectional view showing a grating device according to a first embodiment of the present disclosure;

FIG. 3 is a graph showing a relationship between steering angle and wavelength in first and second waveguides in the grating device according to the first embodiment of the present disclosure.

FIG. 4 is a graph showing a relationship between transmission and wavelength in first and second waveguides in the grating device according to the first embodiment of the present disclosure.

FIG. 5 is a cross-sectional view showing a light-emitting unit according to a second embodiment of the present disclosure;

FIG. 6 is a cross-sectional view showing a light-emitting unit according to a third embodiment of the present disclosure;

FIG. 7 is a cross-sectional view showing a light-emitting unit according to a fourth embodiment of the present disclosure;

FIG. 8 is a cross-sectional view showing a light-emitting unit according to a fifth embodiment of the present disclosure;

FIGS. 9 and 10 are schematic diagram and simulation image of a beam splitter used in the light-emitting unit, respectively;

FIG. 11 is a schematic diagram showing a lidar according to a sixth embodiment of the present disclosure;

FIG. 12 is a flowchart showing some steps of an optical detection method of the lidar according to the sixth embodiment of the present disclosure;

FIG. 13 is a schematic diagram showing a lidar system according to a seventh embodiment of the present disclosure; and

FIG. 14 is a flowchart showing some steps of an optical detection method of the lidar system according to the seventh embodiment of the present disclosure.

### DETAILED DESCRIPTION OF EMBODIMENTS OF THE DISCLOSURE

Exemplary embodiments of the present disclosure will be described in more details below with reference to the accompanying drawings. In the drawings, like reference numerals indicate like elements.

Some particular details of the present disclosure will be described below, such as specific circuit modules, elements, connection manners, control timing sequence, for better understanding of the present disclosure. However, it can be understood by one skilled person in the art that these details are not always essential for but can be varied in a specific implementation of the disclosure.

FIG. 1 is a cross-sectional view showing a conventional grating device. The grating device 10 includes a substrate 11, a blocking layer 12, a waveguide 13, and a cladding layer 14.

The substrate 11 may be made of silicon, on which semiconductor devices such as transistors may also be formed. Thus, the grating device may be integrated with a signal processing circuit as a single lidar chip.

The blocking layer 12 may be formed between the substrate 11 and the waveguide 13 so as to confine a laser beam to propagate through the waveguide 13. The blocking layer is made of, for example but not limited to, silicon oxide.

The waveguide 13 may be an array of strips, wherein the strips are parallel to each other and the array extends in a direction perpendicular to a propagation direction of the laser beam. The waveguide 13 may be made of silicon. For example, a plurality of trenches may be formed in a silicon layer by etching. The strips are remaining portions of the silicon layer, which are aligned in an array and separated from each other by the plurality of trenches. The waveguide 13 has a filling factor f_{y}, which is a ratio between a width L_{GC} of each of the strips and a period width Λ of the strips. As shown in FIG. 1, the period of the strips includes a trench and a cladding filled between two neighboring trenches, the period width is the combined width between a trench and a width of cladding between two neighboring strips.

The cladding layer 14 covers the waveguide 13, for confining a laser beam to propagate through the waveguide 13 and for protecting the waveguide 13 from environmental pollutants. The cladding layer 14 may be made of silicon oxide.

A plurality of strips in waveguide 13 have the function of a grating, which changes a propagation direction of the laser beam by diffraction. For example, the propagation direction of the laser beam is perpendicular to the extension direction of the plurality of strips in the waveguide 13. The laser beam is steered by the waveguide 13, and emits as an output beam, at one main surface that is opposite to the substrate 11 of the waveguide 13.

A steering of the output beam which is generated by the waveguide 13 may be calculated according to the following equation (1),

kn_{eff}=kn_{c} sin θ+2πq/Λ (1),

Where n_{eff} represents an effective refraction index of the waveguide, n_{c} represents a refraction index of the cladding layer (for example, silicon oxide is 1.45), θ represents a steering angle with respect to a normal direction of the main surface of the waveguide 13, Λ represents a period of the grating, q represents an order of diffraction (1 for a grating structure in the waveguide 13), k=2π/λ, λ represents a wavelength of the laser source.

The grating device 10 can be used when tuning a steering angle of an output beam. For example, a tunable laser source (TLS) generates a source beam with a plurality of wavelengths. The source beam propagates through the grating device 10 to generate an output beam by diffraction, with a steering angle corresponding to the wavelength of the source beam. Thus, the steering angle of the output beam can be tuned by controlling the wavelength of the source beam. As mentioned above, a large wavelength range can only have a moderate angle range in the grating device 10. For example, a wavelength range of around 80 nm can only have an angle range of 15 degrees.

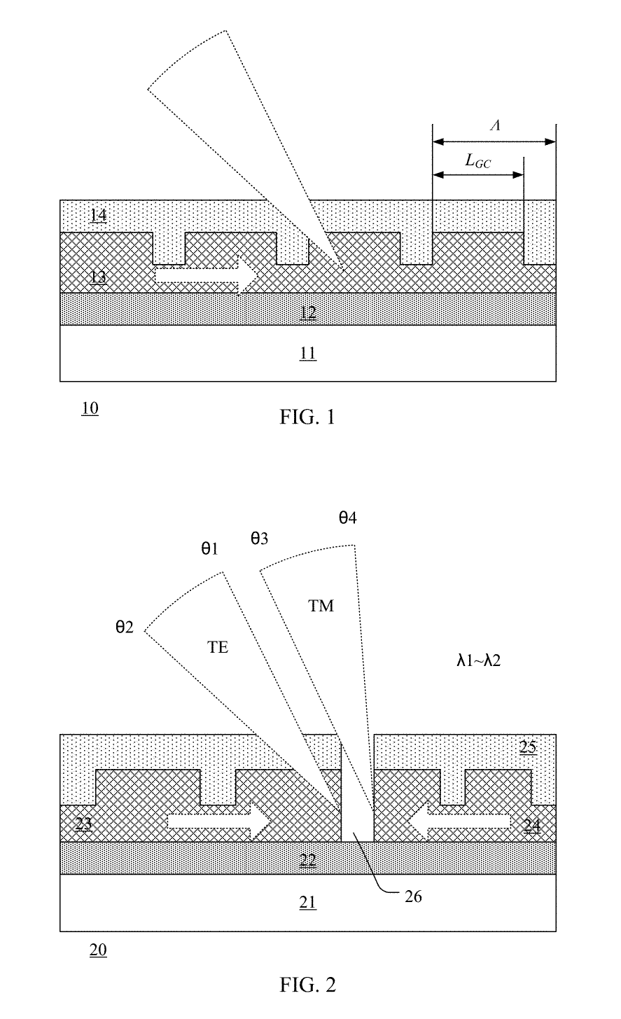

FIG. 2 is a cross-sectional view showing a grating device according to a first embodiment of the present disclosure. The grating device 20 includes a substrate 21, a blocking layer 22 on the substrate 21, a first waveguide 23 and a second waveguide 24 on the blocking layer 22, and a cladding layer 25 on the first waveguide 23 and the second waveguide 24. Preferably, the grating device 20 further includes a gap 26 which separates the first waveguide 23 from the second waveguide 24.

The substrate 21 may be made of silicon, on which semiconductor devices such as transistors may also be formed. Thus, the grating device may be integrated with a signal processing circuit as a single lidar chip.

The blocking layer 22 may be formed between the substrate 21 and the first waveguide 23 and the second waveguide 24 so as to confine a laser beam to propagate through the first waveguide 23 and the second waveguide 24. The blocking layer is made of, for example, silicon oxide.

Each of the first waveguide 23 and the second waveguide 24 may be an array of strips, wherein the strips are parallel to each other and the array extends in a direction perpendicular to propagation direction of the laser beam. Each of the first waveguide 23 and the second waveguide 24 may be made of silicon. For example, a plurality of trenches may be formed in a silicon layer by etching. The strips are remaining portions of the silicon layer, which are aligned in an array and separated from each other by the plurality of trenches.

Preferably, the cladding layer 25 covers the first waveguide 23 and the second waveguide 24, for confining input beams to propagate through the first waveguide 23 and the second waveguide 24 and for protecting the first waveguide 23 and the second waveguide 24 from environmental pollutants. The cladding layer 25 may be made of silicon oxide.

In this embodiment, each of the first waveguide 23 and the second waveguide 24 may be made from one selected from the group consisting of silicon, silicon oxide, silicon nitride, gallium arsenide, indium phosphide, and liquid crystal. The blocking layer 22 may be made of any material that has a refraction index smaller than that of the first waveguide 23 and the second waveguide 24. The cladding layer 25 is made of a transparent material.

In a preferable embodiment, the substrate 21 and the blocking layer 22 are a substrate and a buried layer of an SOI wafer, and the first waveguide 23 and the second waveguide 24 are formed by patterning a silicon layer (as a propagation layer) of the SOI wafer. The cladding layer is made of silicon oxide which is deposited on the first waveguide 23 and the second waveguide 24.

Each of the first waveguide 23 and the second waveguide 24 includes a plurality of strips. The strips have the function of a grating, which changes a propagation direction of an input beam by diffraction. For example, the propagation direction of the input beam is perpendicular to the extension direction of the plurality of strips in the first waveguide 23 and the second waveguide 24. The input beam is steered by one of the first waveguide 23 and the second waveguide 24, and emits as an output beam, at one main surface that is opposite to the substrate 21 of the first waveguide 23 and the second waveguide 24. The first waveguide 23 and the second waveguide 24 may be aligned or staggered to each other. Preferably, there is a gap 26 which separates the first waveguide 23 and the second waveguide 24 to prevent crosstalk between two waveguides.

In this embodiment, the gap 26 extends from a surface of the cladding layer 25 to a surface of the blocking layer 22, penetrating the propagation layer in which the first waveguide 23 and the second waveguide 24 are formed. Alternatively, the gap 26 only penetrates the propagation layer in which the first waveguide 23 and the second waveguide 24 are formed, and the cladding layer 25 fills the gap 26.

The grating device 20 can be used when tuning a steering angle of an output beam. For example, a tunable laser source (TLS) generates an input beam with a plurality of wavelengths. The input beam propagates through the grating device 20 to generate an output beam by diffraction, with a steering angle corresponding to the wavelength of the source beam. Referring to equation (1), the steering angle of the output beam can be tuned by controlling the wavelength of the source beam.

Referring to equation (1), the steering angle θ of the output beam from the first waveguide 23 and the second waveguide 24 is related to an effective refraction index n_{eff}.

Two input beams with different polarization modes, for example, a first input beam of a TE mode and a second input beam of a TM mode, propagate in the first waveguide 23 and the second waveguide 24, respectively. The effective refractive indexes of the first input beam and the second input beam are given as follows,

$$\begin{matrix}\frac{1}{{n}_{TE}} = \sqrt{\frac{{f}_{y}}{{n}_{c}^{2}} + \frac{( 1 - {f}_{y} )}{{n}_{si}^{2}}} , & ( 2 ) \\ \frac{1}{{n}_{TM}} = \sqrt{{n}_{c}^{2} {f}_{y} + {n}_{si}^{2} ( 1 - {f}_{y} )} , & ( 3 )\end{matrix}$$

where n_{TE} and n_{TM} represent effective refraction indexes of the first waveguide and the second waveguide, respectively, n_{c} represents a refraction index of the cladding layer (for example, silicon oxide is 1.45), nₛᵢ represents a refraction index of the propagation layer (for example, silicon is 3.47), f_{y} represents a filling factor of the grating structure.

In the grating structure of the first waveguide 23 and the second waveguide 24 in FIG. 2, the grating structure includes a plurality of strips aligned to be parallel to each other with a repeating period, the filling factor f_{y} is a ratio between a width L_{GC} of each of said strips and a period Λ of said strips. L_{GC} is a length or width of the grating coupler. A period of the strips includes a length of width of the grating coupler and a length or distance between two neighboring grating couplers as shown in at least FIG. 1.

It is known from a combination of equations (1) to (3) that when a first input beam of TE mode propagates through a first waveguide 23 and a second input beam of TM mode propagates through a second waveguide 24, two output beams will be generated by steering the first and second input beams by diffraction with different steering angles, even in a case that a laser source provide a source beam having a fixed wavelength range λ1˜λ2. Because the first input beam and the second input beam have different polarization modes, and the first waveguide 23 and the second waveguide 24 have different filling factors, an output beam from the first waveguide 23 will have a first angle range θ1˜θ2, and an output beam from the second waveguide 24 will have a second angle range θ3˜θ4 which is different from the first angle range.

The grating device 20 stitches the first angle range and the second angle range. For example, the first angle range continues, overlaps with, or separates from the second angle range. Thus, the grating device 20 has an angle range by stitching two angle ranges of two input beams having different polarization modes, which is broader than an angle range of one input beam having a single polarization mode. Even in a case that the laser source has a fixed wavelength range, the grating device 20 can still expand an angle range of steering angles in wavelength tuning.

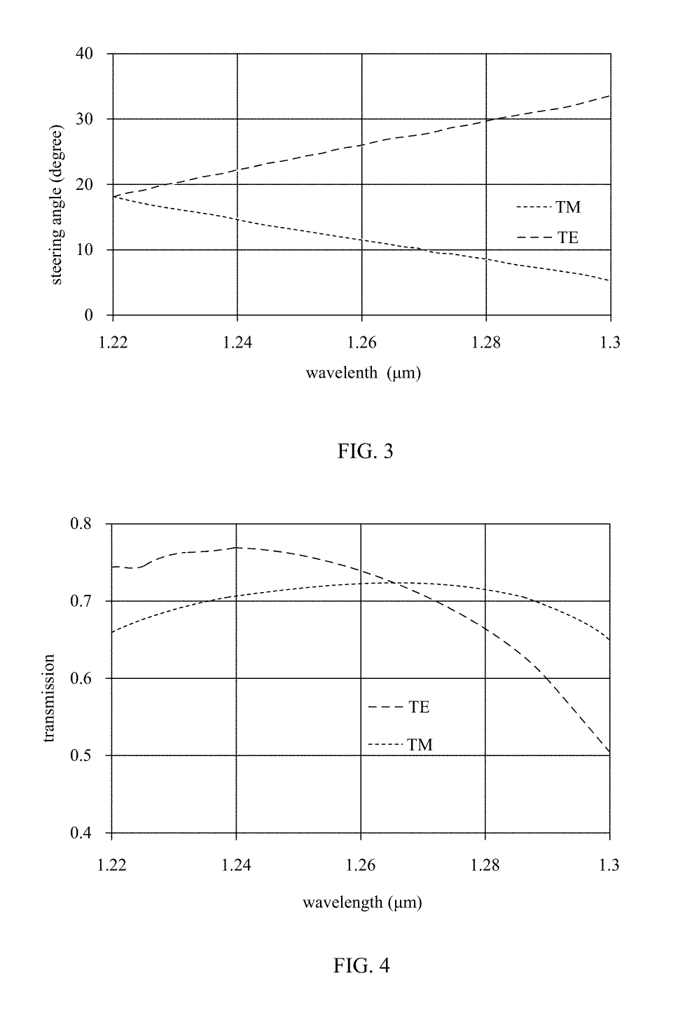

FIG. 3 is a graph showing a relationship between steering angle and wavelength in first and second waveguides in the grating device according to the first embodiment of the present disclosure, and FIG. 4 is a graph showing a relationship between transmission and wavelength in first and second waveguides in the grating device according to the first embodiment of the present disclosure.

A first input beam of TE mode propagates through the first waveguide 23 of the grating device 20, and a second input beam of the TM mode propagates through the second waveguide 24 of the grating device 20.

In this embodiment, the first input beam propagates towards the second input beam. That is, both of the first and second input beams propagate towards the gap 26. Alternatively, the first input beam propagates away from the second input beam. That is, both of the first and second input beams propagates away from the gaps 23.

The first waveguide 23 and the second waveguide 24 are designed to have predetermined filling factors f_{y}, so that an output beam from the first waveguide 23 has a first angle range between −18.1 degrees and −34.3 degrees, and an output beam from the second waveguide 24 has a second angle range between −18.1 degrees and −4.7 degrees, when a laser source has a wavelength range between 1.22 micrometers and 1.3 micrometers. The first angle range continues the second angle range. Thus, the grating device 20 can have an angle range of steering angles between −34.3 degrees and −4.7 degrees by wavelength tuning.

Within the above wavelength range, an output beam from the first waveguide 23 has transmission varying from 0.75 to 0.5, and an output beam from the second waveguide 24 has transmission varying from 0.67 to 0.5. There is a transmission difference between the output beam from the first waveguide 23 and the output beam from the second waveguide 24. Accordingly, there is a light intensity difference when the output beam from the first waveguide 23 and the output beam from the second waveguide 24 illuminate an object. Nevertheless, the light intensity difference is not large enough to interfere with a detection signal. The lidar using the grating device can still work normally.

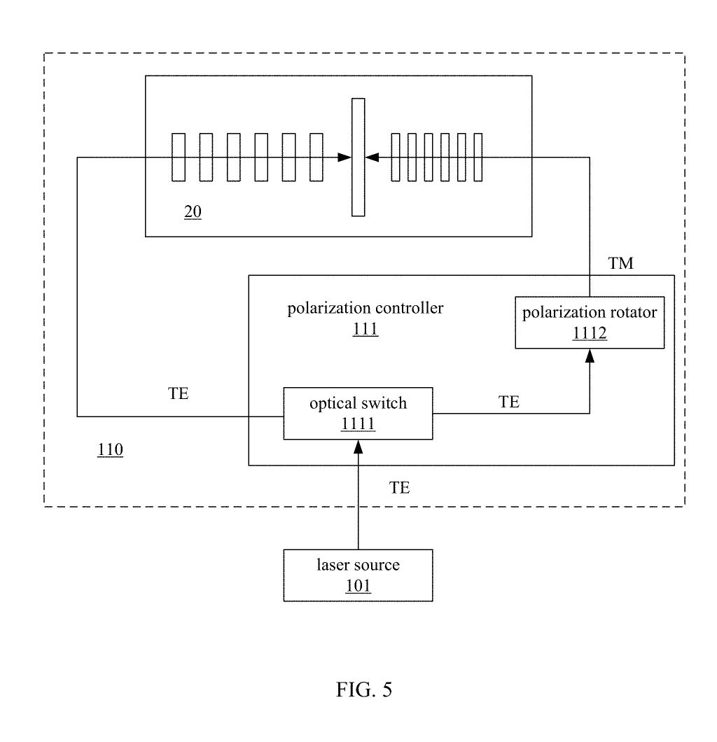

FIG. 5 is a cross-sectional view showing a light-emitting unit according to a second embodiment of the present disclosure. A light-emitting unit 110 includes a grating device 20 and a polarization controller 111.

The grating device 20 has a structure shown in FIG. 2, and includes a first waveguide 23 and a second waveguide 24.

A laser source 101 may generate a source beam of a TE mode, as a first input beam. The polarization controller 111 generates a second input beam of a TM mode from the source beam. Moreover, the polarization controller 111 may select one of the first and second input beams.

The grating device 20 is coupled to the polarization controller 111 laser. The first waveguide 23 receives the first input beam of the TE mode, and the second waveguide 24 receives the second beam of the TM mode. Two output beams are generated by steering the first and second input beams by diffraction respectively, with different steering angles, at least, at one wavelength.

In this embodiment, the laser source 101 generates the source beam of the TE mode. The polarization controller 111 includes an optical switch 1111 and a polarization rotator 1112. The optical switch 1111 selectively supplies the source beam to a first path, as the first input beam, or to a second path. The polarization rotator 1112 is coupled to the optical switch 1111 via the second path, and converts the source beam into the second input beam of the TM mode. The optical switch 1111 supplies the first input beam to the first waveguide of the grating device 20 via the first path, and the polarization rotator 1112 supplies the second input beam to the second waveguide of the grating device 20 via the third path.

In the grating device 20, the first input beam of the TE mode propagates through the first waveguide 23, and the second input beam of the TM mode propagates through the second waveguide 24. The output beams are generated by steering the first and second input beams by diffraction. In a case that the laser source has a fixed wavelength range, the grating device 20 has a large angle range by stitching a first angle range of the output beam from the first waveguide 23 and a second angle range of the output beam from the second waveguide 24. For example, the first angle range continues, overlaps with, or separates from the second angle range. Thus, the grating device 20 using two waveguides can have an angle range broader than that of a grating device using one waveguide.

Even in a case the laser source 101 has a fixed wavelength range, the light-emitting unit 110 emits the output beams from the first waveguide which steers the first input beam of the TE mode by diffraction, and from the second waveguide which steers the second input beam of the TM mode by diffraction, so as to have a larger angle range of steering angles.

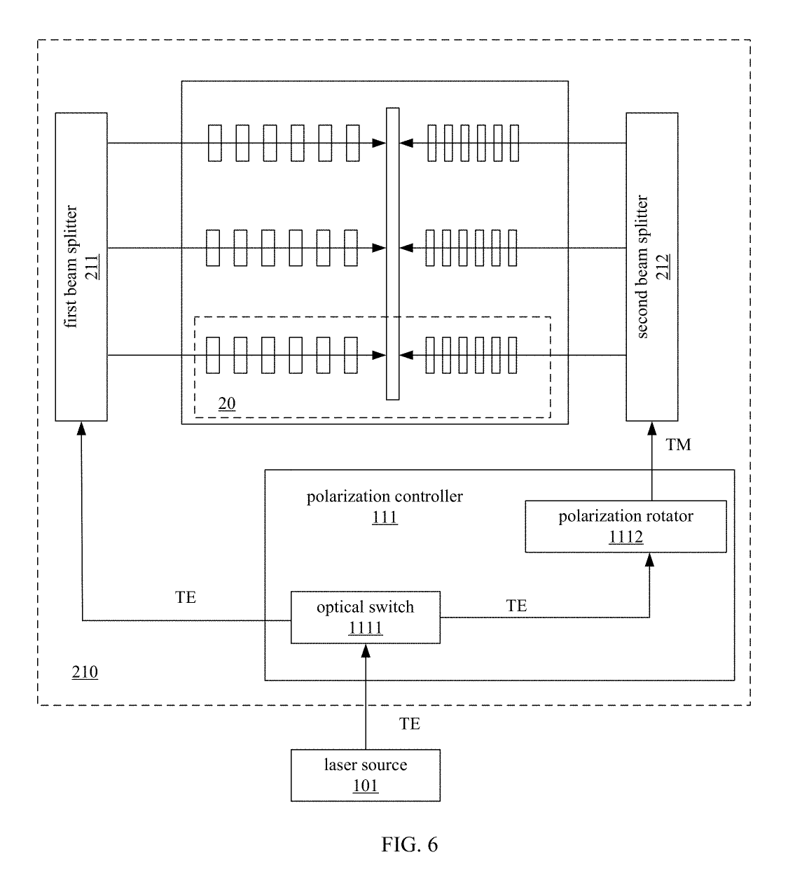

FIG. 6 is a cross-sectional view showing a light-emitting unit according to a third embodiment of the present disclosure. A light-emitting unit 210 includes a plurality of grating devices 20, a polarization controller 111, a first beam splitter 211, and a second beam splitter 212.

The plurality of grating devices 20 are aligned in an array, and preferably, share a common substrate and a common blocking layer in a single chip. Each of the plurality of grating devices 20 has a structure shown in FIG. 2, and includes a first waveguide 23 and a second waveguide 24.

A laser source 101 may generate a source beam of a TE mode, as a first input beam. The polarization controller 111 generates a second input beam of a TM mode from the source beam. Moreover, the polarization controller 111 may select one of the first and second input beams. The light source 101 and polarization controller 111 in the light-emitting unit according to the third embodiment are the same as those in the second embodiment, and will not be described in detail herein.

The first beam splitter 211 is coupled between the polarization controller 111 and the plurality of grating devices 20, for splitting the first input beam into a plurality of feeding beams which are provided to the first waveguide 23, corresponding to one of the plurality of grating devices 20. The second beam splitter 212 is coupled between the polarization controller 111 and the plurality of grating devices 20, for splitting the second input beam into a plurality of feeding beams which are provided to the second waveguide 23, corresponding one of the plurality of grating devices 20. In each of the plurality of grating devices 20, the first waveguide 23 receives a portion of the first input beam of the TE mode, the second waveguide 24 receives a portion of the second input beam of the TM mode. The output beams are generated by steering the first and second input beams by diffraction, with steering angles different, at least, at one wavelength.

In each of the plurality of grating devices 20, a portion of the first input beam of the TE mode propagates through the first waveguide 23, and a portion of the second input beam of the TM mode propagates through the second waveguide 24. In a case that the laser source has a fixed wavelength range, each of the plurality of grating devices 20 has a large angle range by stitching a first angle range of the output beam from the first waveguide 23 and a second angle range of the output beam from the second waveguide 24. For example, the first angle range continues, overlaps with, or separates from the second angle range. Thus, the grating device 20 using two waveguides can have an angle range broader than that of a grating device using one waveguide.

The light-emitting unit 210 according to the third embodiment includes a plurality of the grating devices 20 to generate a plurality of output beams having the same steering angle. Thus, line scanning using one output beam can be enhanced to be area scanning using a plurality of output beams. The light-emitting unit 210 have a large scanning area, which increases a detection range in the far field of the lidar using the light-emitting unit 210.

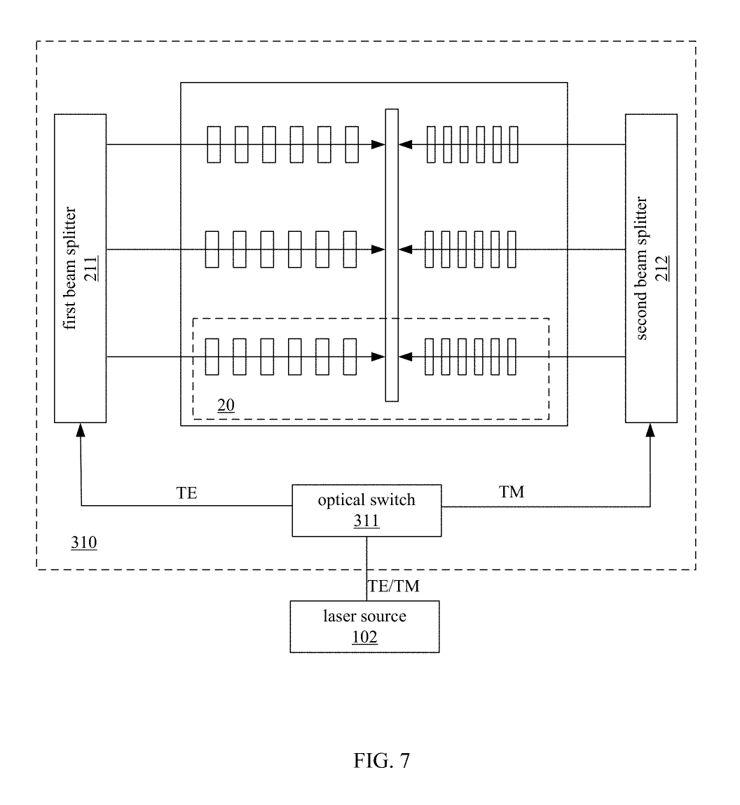

FIG. 7 is a cross-sectional view showing a light-emitting unit according to a fourth embodiment of the present disclosure. A light-emitting unit 310 includes a plurality of grating devices 20, an optical switch 311, a first beam splitter 211, and a second beam splitter 212.

The plurality of grating devices 20 are aligned in an array, and preferably, share a common substrate and a common blocking layer in a single chip. Each of the plurality of grating devices 20 has a structure shown in FIG. 2, and includes a first waveguide 23 and a second waveguide 24.

A laser source 102 may generate a source beam which is adjusted to be one of a TE mode and a TM mode. Here, the optical switch 311 is used as a polarization controller. The optical switch 311 is coupled to the laser source 102 to receive the source beam, and supplies the source beam of the TE mode to the first waveguide of each of the plurality of grating devices 20 via a first path, as a first input beam, and supplies the source beam of the TM mode to the second waveguide of each of the plurality of grating devices 20 via a second path, as a second input beam.

The first beam splitter 211 is coupled between the optical switch 311 and the plurality of grating devices 20, for splitting the first input beam into a plurality of feeding beams which are provided to the first waveguide 23, corresponding to the plurality of grating devices 20. The second beam splitter 212 is coupled between the optical switch 311 and the plurality of grating devices 20, for splitting the second input beam into a plurality of feeding beams which are provided to the second waveguide 23, corresponding to the plurality of grating devices 20. In each of the plurality of grating devices 20, the first waveguide 23 receives a portion of the first input beam of the TE mode, the second waveguide 24 receives a portion of the second input beam of the TM mode. The output beams are generated by steering the first and second input beams by diffraction, with steering angles different, at least, at one wavelength.

In each of the plurality of grating devices 20, a portion of the first input beam of the TE mode propagates through the first waveguide 23, and a portion of the second input beam of the TM mode propagates through the second waveguide 24. In a case that the laser source has a fixed wavelength range, each of the plurality of grating devices 20 has a large angle range by stitching a first angle range of the output beam from the first waveguide 23 and a second angle range of the output beam from the second waveguide 24. For example, the first angle range continues, overlaps with, or separates from the second angle range. Thus, the grating device 20 using two waveguides can have an angle range broader than that of a grating device using one waveguide.

The light-emitting unit 310 according to the fourth embodiment includes a plurality of the grating devices 20 to generate a plurality of output beams having the same steering angle. Thus, line scanning using one output beam can be enhanced to be area scanning using a plurality of output beams. The light-emitting unit 310 have a large scanning area, which increases a detection range in the far field of the lidar using the light-emitting unit 310. Moreover, the laser source 102 generates a source beam which is adjusted to be one of a TE mode and a TM mode. Thus, the polarization controller can have a simple structure, including only an optical switch, which further reduces light loss in the polarization controller.

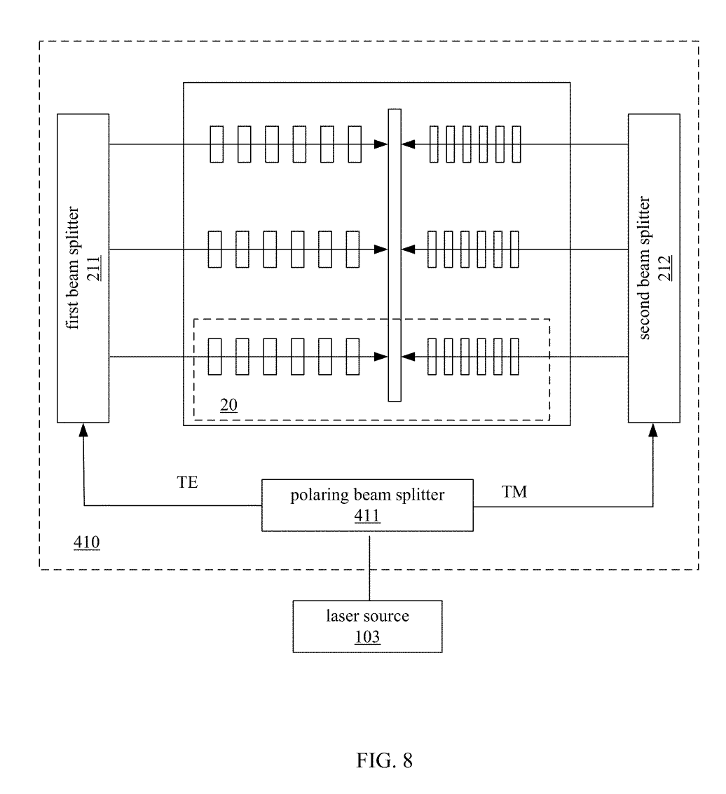

FIG. 8 is a cross-sectional view showing a light-emitting unit according to a fifth embodiment of the present disclosure. A light-emitting unit 410 includes a plurality of grating devices 20, a polarizing beam splitter 411, a first beam splitter 211, and a second beam splitter 212.

The plurality of grating devices 20 are aligned in an array, and preferably, share a common substrate and a common blocking layer in a single chip. Each of the plurality of grating devices 20 has a structure shown in FIG. 2, and includes a first waveguide 23 and a second waveguide 24.

A laser source 103 may generate a source beam which is not polarized. Here, the polarizing beam splitter 411 is used as a polarization controller. The polarizing beam splitter 411 is coupled to the laser source 102 to receive the source beam, and polarized the source beam to be a first input beam of a TE mode or to be a second input beam of a TM mode. The polarizing beam splitter 411 supplies the first input beam of the TE mode to the first waveguide 23 of each of the plurality of grating devices 20 via a first path, as a second input beam, and supplies the second input beam of the TM mode to the second waveguide 24 of each of the plurality of grating devices 20 via a second path.

The first beam splitter 211 is coupled between the polarizing beam splitter 411 and the plurality of grating devices 20, for splitting the first input beam into a plurality of feeding beams which are provided to the first waveguide 23, corresponding to of the plurality of grating devices 20. The second beam splitter 212 is coupled between the polarizing beam splitter 411 and the plurality of grating devices 20, for splitting the second input beam into a plurality of feeding beams which are provided to the second waveguide 23, corresponding to the plurality of grating devices 20. In each of the plurality of grating devices 20, the first waveguide 23 receives a portion of the first input beam of the TE mode, the second waveguide 24 receives a portion of the second input beam of the TM mode. The output beams are generated by steering the first and second input beams by diffraction, with steering angles different, at least, at one wavelength.

In each of the plurality of grating devices 20, a portion of the first input beam of the TE mode propagates through the first waveguide 23, and a portion of the second input beam of the TM mode propagates through the second waveguide 24. In a case that the laser source has a fixed wavelength range, each of the plurality of grating devices 20 has a large angle range by stitching a first angle range of the output beam from the first waveguide 23 and a second angle range of the output beam from the second waveguide 24. For example, the first angle range continues, overlaps with, or separates from the second angle range. Thus, the grating device 20 using two waveguides can have an angle range broader than that of a grating device using one waveguide.

The light-emitting unit 410 according to the fifth embodiment includes a plurality of the grating devices 20 to generate a plurality of output beams having the same steering angle. Thus, line scanning using one output beam can be enhanced to be area scanning using a plurality of output beams. The light-emitting unit 310 have a large scanning area, which increases a detection range in the far field of the lidar using the light-emitting unit 310. Moreover, the laser source 102 generates a source beam which is not polarized and the polarizing beam splitter 411 converts the source beam into the first input beam of the TE mode and the second input beam of the TM mode. Thus, the polarization controller can have a simple structure, including only a polarizing beam splitter, which further reduces light loss in the polarization controller.

FIG. 9 is a schematic diagram of a beam splitter used in the light-emitting unit. Each of the first beam splitter 211 and the second beam splitter 212 includes a plurality Y-splitters, which are coupled with each other in cascade and split an input beam into a plurality of beams for a plurality of grating devices.

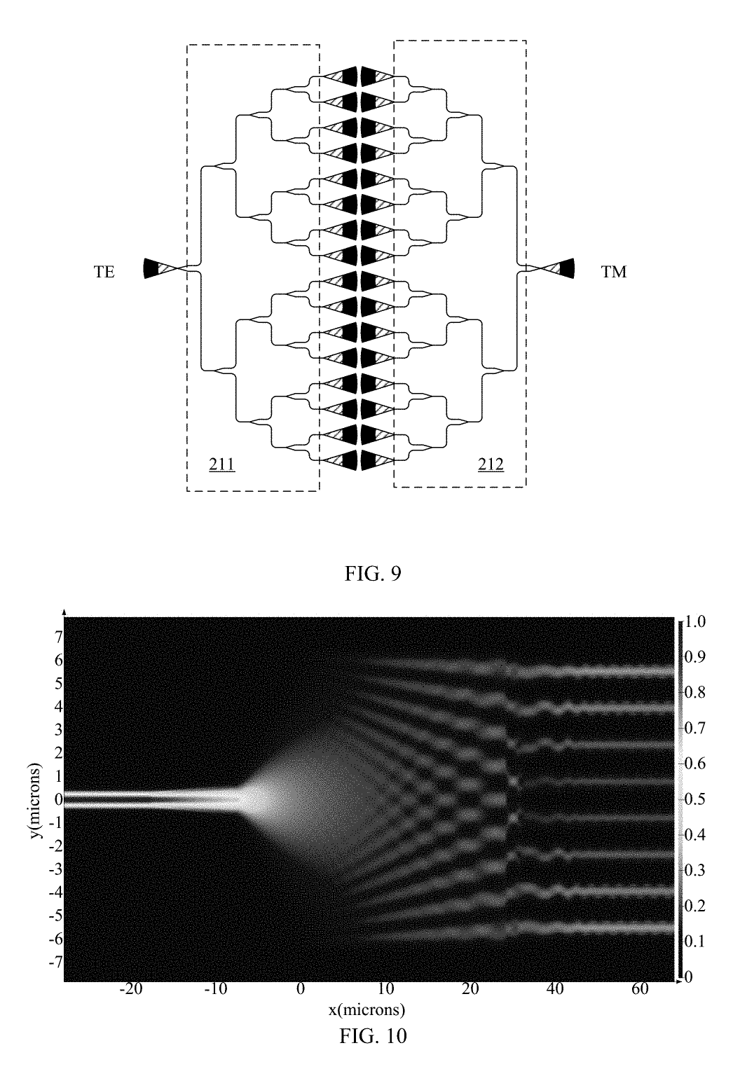

FIG. 10 shows simulation images of a beam splitter used in the light-emitting unit. The first beam splitter 211 and the second beam splitter 212 are implemented by multi-mode interference couplers, which are coupled with each other in cascade and split an input beam into a plurality of beams for a plurality of grating devices. Alternatively, the first beam splitter 211 and the second beam splitter 212 are implemented by star couplers.

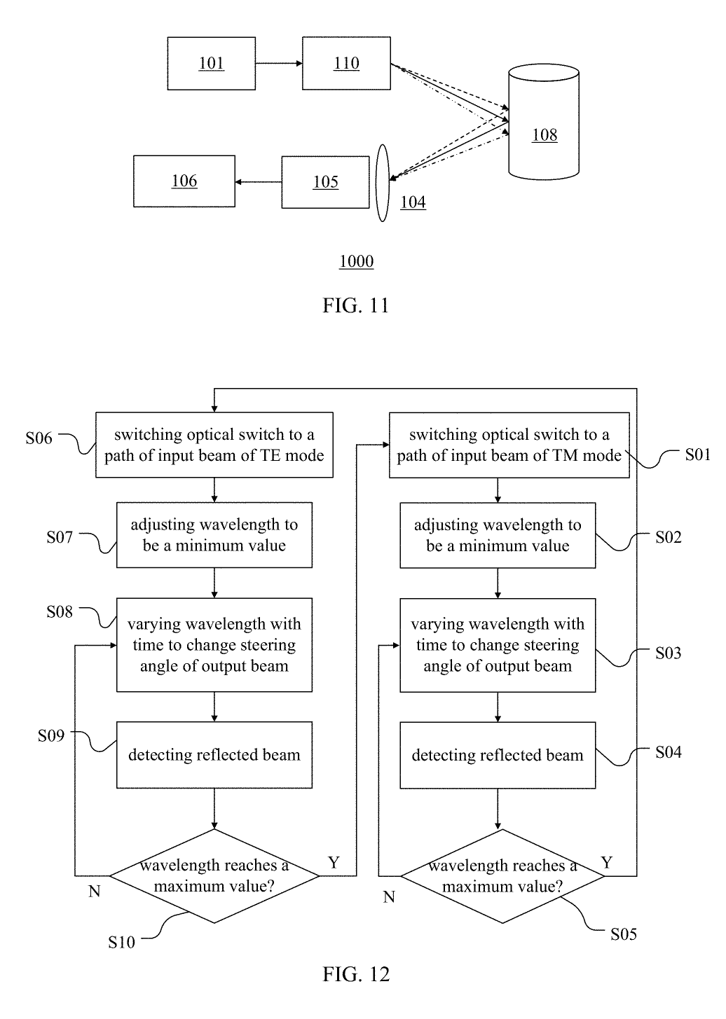

FIG. 11 is a schematic diagram showing a lidar according to a sixth embodiment of the present disclosure. A lidar 1000 includes a laser source 101, a light-emitting unit 110, a lens 104, an optical detection unit 105, and a signal processing unit 106. The light-emitting unit 110 has a structure shown in FIG. 5.

In this embodiment, the lidar 1000 is a scanning lidar. The laser source 101 can generate a narrow-band source beam, for example of a TE mode, having a wavelength which varies with time. The light-emitting unit 110 is coupled with the laser source 101, receives the source beam from the laser source 101, generates a plurality of output beams by diffraction, which have steering angles corresponding to said plurality of wavelengths, and illuminates the plurality of output beams onto an object 108. The lens 104 is located between the object 108 and the optical detection unit 105 and enhances the intensity of the reflected beam. The optical detection unit 105 obtains reflected beams from the object 108 to generate a detection signal. The signal processing unit 106 is coupled with the optical detection unit 105 to receive the detection signal and processes the detection signal to represent a distance of the object 108.

FIG. 12 is a flowchart showing some steps of an optical detection method of the lidar according to the sixth embodiment of the present disclosure. The method is applied to the lidar 1000 shown in FIG. 11. The laser source 101 can generate a narrow-band source beam of a TE mode, having a wavelength which varies with time. The light-emitting unit 110 has a structure shown in FIG. 5.

As mentioned above, the light detection method includes the steps of generating output beams and detecting reflected beams, and specifically, includes the following steps S01 to S10.

In step S01, the optical switch 1111 in the light-emitting unit 110 is switched to a second path so that the polarization rotator 1112 is coupled to the optical switch 1111 and the source beam of the TE mode is converted into a second input beam of the TM mode. The second input beam of the TM mode propagates through the second waveguide 24 of the grating device 20, and emitted as an output beam therefrom.

In step S02, the laser source 101 is adjusted to generate the source beam having a minimum wavelength. The second waveguide 24 of the grating device 20 steers the second input beam to generate the output beam with a steering angle corresponding to the minimum wavelength.

In step S03, the laser source 101 is adjusted to vary the wavelength of the source beam with time. The second waveguide 24 of the grating device 20 steers the second input beam to generate the output beam with a steering angle corresponding to the varied wavelength.

In step S04, the optical detection unit 105 obtains a reflected beam from the object and generates a detection signal.

In step S05, it is determined whether the wavelength of the source beam generated by the laser source 101 reaches a maximum wavelength. If NOT, the steps S03 to S05 are repeated. If YES, step S 06 will be performed.

In step S06, the optical switch 1111 in the light-emitting unit 110 is switched to a first path so that the optical switch 1111 is coupled to first waveguide 23 of the grating device 20 via the first path. The first input beam of the TE mode propagates through the first waveguide 23 of the grating device 20, and emitted as an output beam therefrom.

In step S07, the laser source 101 is adjusted to generate the source beam having a minimum wavelength. The first waveguide 23 of the grating device 20 steers the first input beam to generate the output beam with a steering angle corresponding to the minimum wavelength.

In step S08, the laser source 101 is adjusted to vary the wavelength of the source beam with time. The first waveguide 23 of the grating device 20 steers the first input beam to generate the output beam with a steering angle corresponding to the varied wavelength.

In step S09, the optical detection unit 105 obtained the reflected beam from the object and generates a detection signal.

In step S10, it is determined whether the wavelength of the source beam generated by the laser source 101 reaches a maximum wavelength. If NOT, the steps S08 to S10 are repeated. If YES, the method will return to perform step S01.

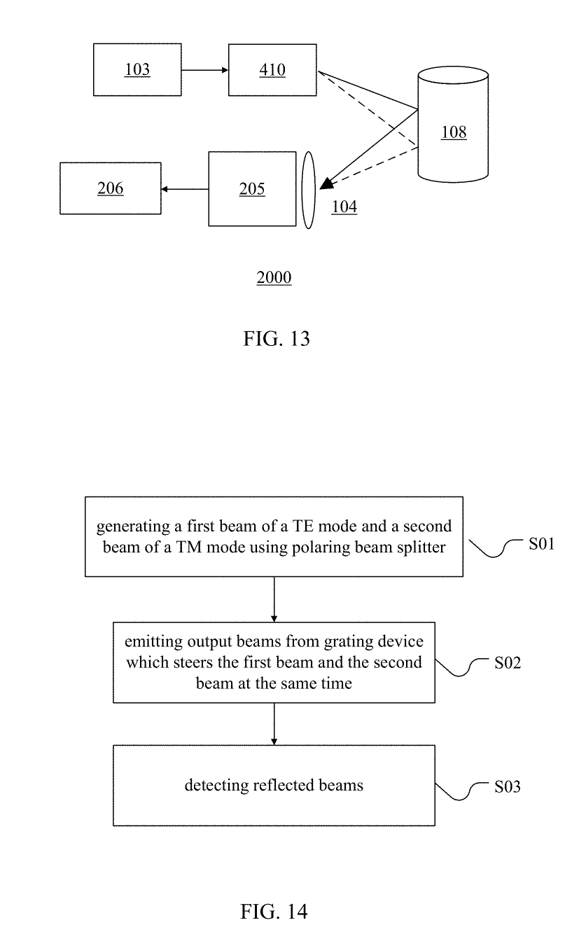

FIG. 13 is a schematic diagram showing a lidar according to a seventh embodiment of the present disclosure. A lidar 2000 includes a laser source 103, a light-emitting unit 410, a lens 104, an optical detection unit 205, and a signal processing unit 206. The light-emitting unit 410 has a structure shown in FIG. 8, in which the polarized beam splitter 411 polarizes a source beam to be either a first input beam of a TE mode or a second input beam of a TM mode.

In this embodiment, the lidar 2000 is a flash lidar. The laser source 103 can generate a broad-band source beam with a plurality of wavelengths. The light-emitting unit 110 is coupled with the laser source 103, receives the source beam from the laser source 103, generates a plurality of output beams by diffraction, which have steering angles corresponding to said plurality of wavelengths, and illuminates the plurality of output beams onto an object 108. The lens 104 is located between the object 108 and the optical detection unit 105 and enhances the intensity of the reflected beam. The optical detection unit 205 may be, for example, an optical detection unit including a plurality of detection units in an array, and obtains reflected beams from the object 108 to generate detection signals. The signal processing unit 206 is coupled with the optical detection unit 205 to receive the detection signals and processes the detection signals to represent a distance of the object 108.

FIG. 14 is a flowchart showing some steps of an optical detection method of the lidar according to the seventh embodiment of the present disclosure. The method is applied to the lidar 2000 shown in FIG. 13. The laser source 103 can generate a broad-band source beam with a plurality of wavelengths. The light-emitting unit 410 has a structure shown in FIG. 8.

As mentioned above, the light detection method includes the steps of generating output beams and detecting reflected beams, and specifically, includes the following steps S01 to S3.

In step S01 the polarizing beam splitter 411 in the light-emitting unit 410 generates both a first input beam of a TE mode with a plurality of wavelengths, and a second input beam of a TM mode with a plurality of wavelengths.

In step S02, a plurality of grating device 20 in the light-emitting unit 410 emit a plurality of output beams which are generated from the first beam of the TE mode and the second beam of the TM mode.

In step S03, the optical detection unit 205 obtains a plurality of reflected beams from an object and generates a plurality of detection signals.

Elements in the embodiments are

10, a grating device

11, a substrate 11,

12, a blocking layer 12,

13, a waveguide 13,

14, a cladding layer 14

20, a grating device of a first embodiment 20

21, a substrate of the first embodiment 21,

22, a blocking layer 22 on the substrate 21,

23, a first waveguide 23,

24, a second waveguide 24 on the blocking layer 22,

25, a cladding layer 25 on the first waveguide 23,

26, gap of the grating device 20

110, an example of a light-emitting unit

111, polarization controller

101, laser source

104, a lens 104

105, an optical detection unit

106, a signal processing unit

108, an object 108

210, another example of a light-emitting unit

211, a first beam splitter

212, a second beam splitter

310, still another example of a light-emitting unit

311, an optical switch

410, yet another example of a light-emitting unit

411, polarizing beam splitter

1000, a lidar or a lidar system

1111, optical switch

1112, polarization rotator

2000, a lidar or a lidar system

It should also be understood that the relational terms such as “first”, “second”, and the like are used in the context merely for distinguishing one element or operation form the other element or operation, instead of meaning or implying any real relationship or order of these elements or operations. Moreover, the terms “comprise”, “comprising” and the like are used to refer to comprise in nonexclusive sense, so that any process, approach, article or apparatus relevant to an element, if follows the terms, means that not only said element listed here, but also those elements not listed explicitly, or those elements inherently included by the process, approach, article or apparatus relevant to said element. If there is no explicit limitation, the wording “comprise a/an . . . ” does not exclude the fact that other elements can also be included together with the process, approach, article or apparatus relevant to the element.

Although various embodiments of the present disclosure are described above, these embodiments neither present all details, nor imply that the present disclosure is limited to these embodiments. Obviously, many modifications and changes may be made in light of the teaching of the above embodiments. These embodiments are presented and some details are described herein only for explaining the principle of the disclosure and its actual use, so that one skilled person can practice the present disclosure and introduce some modifications in light of the disclosure. The disclosure is intended to cover alternatives, modifications and equivalents that may be included within the spirit and scope of the disclosure as defined by the appended claims.

What is claimed is:

1. A grating device, comprising:
a substrate;
a blocking layer on the substrate;
a first waveguide on a first region of the blocking layer;
a second waveguide on a second region of the blocking layer;
a first input beam of a TE mode, capable of propagating through the first waveguide;
a second input beam of a TM mode, capable of propagating through the second waveguide;
wherein
the grating device generates output beams by steering the first and second input beams by diffraction, with different steering angles, at least, at one wavelength.

2. The grating device according to claim 1, wherein
each of the first and second waveguides comprises an array of strips where the strips are parallel to each other and the array extends in a direction perpendicular to propagation direction of the first and second input beams.

3. The grating device according to claim 1, wherein
the first waveguide has a filling factor, which is a ratio between a width of each of the strips and a period of the strips, greater than that of the second waveguide.

4. The grating device according to claim 1, wherein the first and second input beams propagate in opposite directions.

5. The grating device according to claim 1, wherein the first and second input beams tune steering angles of the output beams by changing wavelengths.

6. The grating device according to claim 5, wherein
the first input beam generates an output beam within a first angle range, the second input beam generates an output beam within a second angle range, and the first angle range is continuous with, overlaps with, or separates from the second angle range.

7. The grating device according to claim 1, further comprising a gap which separates the first waveguide from the waveguide.

8. The grating device according to claim 1, further comprising a cladding layer on the first and second waveguides.

9. A light-emitting unit, comprising:
a polarization controller configured to generate a first input beam of a TE mode and a second input beam of a TM mode; and
one or more grating devices which are coupled to the polarization controller to receive the first and second input beams,
wherein each of the one or more grating devices comprises:
a substrate;
a blocking layer on the substrate;
a first waveguide on a first region of the blocking layer, through which the first input beam of the TE mode propagates; and
a second waveguide on a second region of the blocking layer, through which the second input beam of the TM mode propagates;
wherein the grating devices generates output beams by steering the first and second input beams by diffraction, with different steering angles, at least, at one wavelength.

10. The light-emitting unit according to claim 9, wherein the source beam has a polarization mode which is either a TE mode or a TM mode, and the polarization controller comprises:
an optical switch configured to selectively provide a source beam to a first path or a second path, as the first input beam; and
a polarization rotator which is coupled to the optical switch through the second path and converts the source beam into a different polarization mode, as the second input beam,
wherein the optical switch provides the first input beam to the first waveguide through the first path, and the polarization rotator provides the second input beam to the second waveguide through a third path.

11. The light-emitting unit according to claim 9, wherein the source beam has a polarization mode which is adjusted to be either a TE mode or a TM mode, and the polarization controller comprises:
an optical switch which is coupled to the first waveguide through a first path and to the second waveguide through a second path,
wherein the optical switch provides the source beam to the first path in a case that the source beam is in the TE mode, as the first input beam, and to the second path in a case that the source beam is in the TM mode, as the second input beam.

12. The light-emitting unit according to claim 9, wherein the source beam is not polarized, and the polarization controller comprises:
a polarizing beam splitter which is coupled to the first waveguide through a first path and to the second waveguide through a second path,
wherein the polarizing beam splitter is configured to polarize the source beam as the first input beam and to provide the first input beam to a first path, and to polarize the source beam as the second input beam and to provide the second input beam to a second path.

13. The light-emitting unit according to claim 9, wherein the one or more grating devices comprise a plurality of grating devices which share the substrate and the blocking layer.

14. The light-emitting unit according to claim 13, further comprising:
a first beam splitter which is coupled between the polarization controller and the plurality of grating devices, and is configured to split the first input beam into a plurality of feeding beams, for the first waveguide corresponding to one of the plurality of grating devices; and
a second beam splitter which is coupled between the polarization controller and the plurality of grating devices, and is configured to split the second input beam into a plurality of feeding beams, for the second waveguide corresponding to one of the plurality of grating devices.

15. The light-emitting unit according to claim 9, wherein the first and second input beams tune steering angles of the output beams by changing wavelengths.

16. The light-emitting unit according to claim 15, wherein the first input beam generates an output beam within a first angle range, the second input beam generates an output beam within a second angle range, and the first angle range continues, overlaps with, or separates from the second angle range.

17. A light detection method, comprising:
generating first and second input beams, which have different polarization modes, from a source beam;
generating output beams by steering the first and second input beams using first and second waveguides, with steering angles corresponding to wavelengths of the first and second input beams;
illuminating the output beams onto an object;
obtaining reflected beams from the object to generate a detection signal; and
processing the detection signal to represent a distance of the object,
wherein the first and second input beams have different steering angles, at least, at one wavelength.

18. The light detection method according to claim 17, wherein the source beam has a polarization mode which is one of a TE mode and a TM mode, and the step of generating the output beams comprises:
selectively providing the source beam to a first path, as the first input beam, and to a second path;
converting the source beam into the second input beam having a polarization mode different from that of the first input beam;
providing the first input beam to the first waveguide through the first path; and
providing the second input beam to the second waveguide through a third path.

19. The light detection method according to claim 17, wherein the source beam has a polarization mode which is adjusted to be either a TE mode or a TM mode, and the step of generating the output beams comprises:
providing the source beam of the TE mode to a first path as the first input beam; and
providing the source beam of the TM mode to a second path as the second input beam.

20. The light detection method according to claim 17, wherein the source beam is a broadband beam, and the step of generating the output beams comprises:
generating the first input beam by polarizing the source beam to a TE mode and providing the first input beam to a first path; and
generating the second input beam by polarizing the source beam to a TM mode and providing the second input beam to a second path.

21. The light detection method according to claim 17, wherein the first and second input beams tune steering angles of the output beams by changing wavelengths.

22. The light detection method according to claim 21, wherein the first input beam generates an output beam within a first angle range, the second input beam generates an output beam within a second angle range, and the first angle range continues, overlaps with, or separates from the second angle range.
